(19) United States
(12) Patent Application Publication
(10) Pub. No.: US 2005/0065937 A1
(43) Pub. Date: Mar. 24, 2005

(54) Virtual resources method, system, and service

(75) Inventors: Louis R. Degenaro, White Plains, NY (US); Isabelle Rouvellou, New York City, NY (US)

Correspondence Address: MCGINN & GIBB, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 10/665,564

(22) Filed: Sep. 22, 2003

(51) Int. Cl. G06F 7/00

(52) U.S. Cl. 707/100

(57) ABSTRACT

A method (and system) of refactoring a plurality of actual resources without alteration into a collection of virtual resources customized to a particular audience, includes constructing at least one virtual resource, connecting at least one actual resource to the at least one virtual resource, retrieving the at least one virtual resource, and extracting at least one descriptor from the at least one retrieved virtual resource.

### BACKGROUND OF THE INVENTION

1. Field of the Invention

The present invention generally relates to a system, service and method for providing virtual resources, and more particularly to a system, service and method for virtual resources which places substantially no requirements upon resources (e.g., existing resources need no changes and new resources need not implement a particular interface).

2. Description of the Related Art

It is often desirable to present different views of an entity to different observers.

For example, to the ordinary constuner interested in purchasing an automobile, the associated sales brochures normally show features of interest, such as interior/exterior colors available, engine size choices, fuel economy, etc. However, to the mechanic charged with servicing the automobile, a service manual with schematics and maintenance procedures concerning the various constituent parts would be more useful.

In both cases, the view (e.g., the sales brochure view or the service manual view) is customized to the intended audience. In both cases, the object of interest (e.g., the particular make and model of automobile) is the same. Each view contains information about the automobile. Making a new view, such as, for example, a salesman's pricing guide, has no effect on the automobile itself or on other views. Moreover, nor does changing the information contained in an existing publication.

That is, the material contained in these various publications is descriptive in nature and is not part of the automobile itself. Further, an actual automobile need not yet exist in order to describe it.

In the sales brochure, there may be a photograph of the engine under the hood. However, a photograph is not sufficient for the service manual to be consulted by the mechanic, where each part of the engine would be uniquely identified together with a description of how to perform maintenance. Conversely, in the salesman's pricing guide, neither a picture nor engine parts and service details appears, but simply the additional cost for each engine type. Each of these distinct printed materials describes the same automobile part from a different perspective.

The above pattern has an analogy in the computer programming world where there exists a plethora of resources (e.g., analogous to automobiles, refrigerators, insurance policies, etc.) available for use by applications (e.g., analogous to consumers, mechanics, agents, etc.).

A resource might be a database table, a Java® Bean, an Enterprise Java® Bean (EJB), a Java® object, a legacy application, a Web Service, a flat file, an eXtensible Markup Language (XML) file, etc.

Each resource type has its own interface. Each interface completely describes the capabilities of the resource. Generally speaking, however, resources do not have different views for different audiences, and usually lack important descriptive information.

Conventional techniques have had several problems. For example, conventional techniques have been unable to escape placement of requirements upon resources (e.g., existing resources need no changes and new resources need not implement a particular interface).

Further, the conventional techniques have not provided a structured meta-data layer which contains descriptions and/or description builder information for one or many views on a large variety of resources and combinations.

Moreover, the conventional techniques have not provided a robust suite of available operations on meta-data for view building and unambiguous association to resource artifacts.

Further, the conventional techniques have not been able to partition meta-data and operations for different uses, such as resource administrators and resource consumers.

Further, no conventional techniques have been useful across diverse programming spheres. Indeed, there has been no technique which has addressed the need for integrating variable business logic authoring with existing application artifacts. As such, there has been no method or service in which a computer application is divided in two main parts with the first part comprising a “constant logic” that is coded, compiled, and deployed by persons skilled in the art of computer programming, and the second part comprising “variable logic” that is composed and engaged by persons who are not. Much must be done to hide complexities from non-programmers when providing logic authoring capabilities. No conventional techniques have been provided to do so.

Thus, prior to the present invention, there has been no method, system, and service to specify, apply, and manage resources in order to expand the universe of artifacts accessible to non-programmer logic composers.

### SUMMARY OF THE INVENTION

In view of the foregoing and other exemplary problems, drawbacks, and disadvantages of the conventional methods and structures, an exemplary feature of the present invention is to provide a method, system, and service for providing virtual resources.

Another exemplary feature of the present invention is to provide a method, system, and service which places no requirements upon resources (e.g., existing resources need no changes and new resources need not implement a particular interface).

Another exemplary feature of the present invention is to provide a method, system, and service which provides a structured meta-data layer which contains descriptions and/or description builder information for one or many views on a large variety of resources and combinations.

Another exemplary feature of the present invention is to provide a method and system which provides a structured meta-data layer which contains semantic information (e.g., relationships with agreed upon semantics, such as “related-to”, “contains”, “is-conflicting-with”, between entities) that can be leveraged by the consumer of the virtual resources (e.g., make new resource manipulation operations available to logic authoring tools or serve as an input to a conflict detection tool).

Yet another exemplary feature of the present invention is to provide a method, system, and service which provides a robust suite of available operations on meta-data for view building and unambiguous association to resource artifacts.

A further exemplary feature of the present invention is to provide a method, system, and service which partitions meta-data and operations for different uses, such as resource administrators and resource consumers.

In a first exemplary aspect of the present invention, a method (and system) of refactoring a plurality of actual resources without alteration into a collection of virtual resources customized to a particular audience, includes constructing at least one virtual resource, connecting at least one actual resource to the at least one virtual resource, performing at least one retrieval of the virtual resource; and extracting at least one descriptor from the at least one retrieved virtual resource.

In a second exemplary aspect of the present invention, a system for refactoring a plurality of actual resources without alteration into a collection of virtual resources customized to a particular audience, includes means for constructing at least one virtual resource, means for connecting at least one actual resource to the at least one virtual resource, means for performing at least one retrieval of the virtual resource, and means for extracting at least one descriptor from the at least one retrieved virtual resource.

In a third exemplary aspect of the present invention, in a system including a plurality of actual resources, a service to manage descriptions of the actual resources includes analyzing a requirement for actual resource usage, defining at least one virtual domain to satisfy the requirement analysis, and defining at least one virtual resource describing as least one actual resource within the at least one virtual domain to satisfy the requirement analysis.

In a fourth exemplary aspect of the present invention, a method of deploying computing infrastructure in which computer-readable code is integrated into a computing system, such that the code and the computing system combine to perform a method of refactoring actual resources without alteration into a collection of virtual resources customized to a particular audience, the method includes constructing at least one virtual resource, connecting at least one actual resource to the at least one virtual resource, retrieving the at least one virtual resource, and extracting at least one descriptor from the at least one retrieved virtual resource.

In a fifth exemplary aspect of the present invention, a signal-bearing medium tangibly embodying a program of machine-readable instructions executable by a digital processing apparatus to perform a method of refactoring the actual resources without alteration into a collection of virtual resources customized to a particular audience, the method including constructing at least one virtual resource, connecting at least one actual resource to the at least one virtual resource, retrieving the at least one virtual resource, and extracting at least one descriptor from the at least one retrieved virtual resource.

With the unique and unobvious aspects of the present invention, a system is provided which places no requirements upon resources (e.g., existing resources need no changes and new resources need not implement a particular interface). Additionally, the invention provides a structured meta-data layer which contains descriptions and/or description builder information for one or many views on a large variety of resources and combinations.

Additionally, the invention provides a structured meta-data layer which contains semantics to be leveraged by the consumer of the virtual resources.

Moreover, the invention provides a robust suite of available operations on meta-data for view building and unambiguous association to resource artifacts.

Additionally, the invention partitions meta-data and operations for different uses, such as resource administrators and resource consumers.

The present invention may be useful across diverse programming spheres. However, in an exemplary application, the invention addresses the need for integrating variable business logic authoring with existing application artifacts. As such, the invention imagines a computer application divided in two main parts: the first part is comprised of “constant logic” that is coded, complied, and deployed by persons skilled in the art of computer programming; the second part is comprised of “variable logic” that is composed and engaged by persons who are not. Much must be done to hide complexities from non-programmers when providing logic authoring capabilities.

Thus, the invention provides a method and service to specify, apply, and manage resources in order to expand the universe of artifacts accessible to non-programmer logic composers. As such, the invention solves the problem of how non-programmers can be enabled to author logic that utilizes artifacts usually accessed programmatically.

### BRIEF DESCRIPTION OF THE DRAWINGS

The foregoing and other exemplary features, purposes, aspects and advantages will be better understood from the following detailed description of an exemplary embodiment of the invention with reference to the drawings, in which:

FIG. 1 illustrates a first exemplary embodiment of a system 100 according to the present invention;

FIG. 2 illustrates a virtual resources life cycle operation 200 for use in authoring according to the present invention;

FIG. 3 illustrates a virtual resources life cycle operation 300 for use in accessing according to the present invention;

FIG. 4 illustrates a structure 400 showing an incomplete state according to the present invention;

FIG. 5 illustrates a structure 500 showing a revising state according to the present invention;

FIG. 6 illustrates a structure 600 showing a cloaking and re-naming state according to the present invention;

FIG. 7 illustrates a structure 700 showing a composing and re-naming state according to the present invention;

FIG. 8 illustrates a structure 800 showing relationships according to the present invention;

FIG. 9 illustrates a structure 900 showing domains according to the present invention;

FIG. 10 illustrates a structure 1000 showing constraints according to the present invention;

FIG. 11 illustrates a structure 1100 showing instances according to the present invention;

FIG. 12 illustrates a structure 1200 showing service according to the present invention;

FIG. 13 illustrates an exemplary hardware/information handling system 1300 for incorporating the present invention therein; and

FIG. 14 illustrates a signal bearing medium 1400 (e.g., storage medium) for storing steps of a program of a method according to the present invention.

### DETAILED DESCRIPTION OF EXEMPLARY EMBODIMENTS OF THE INVENTION

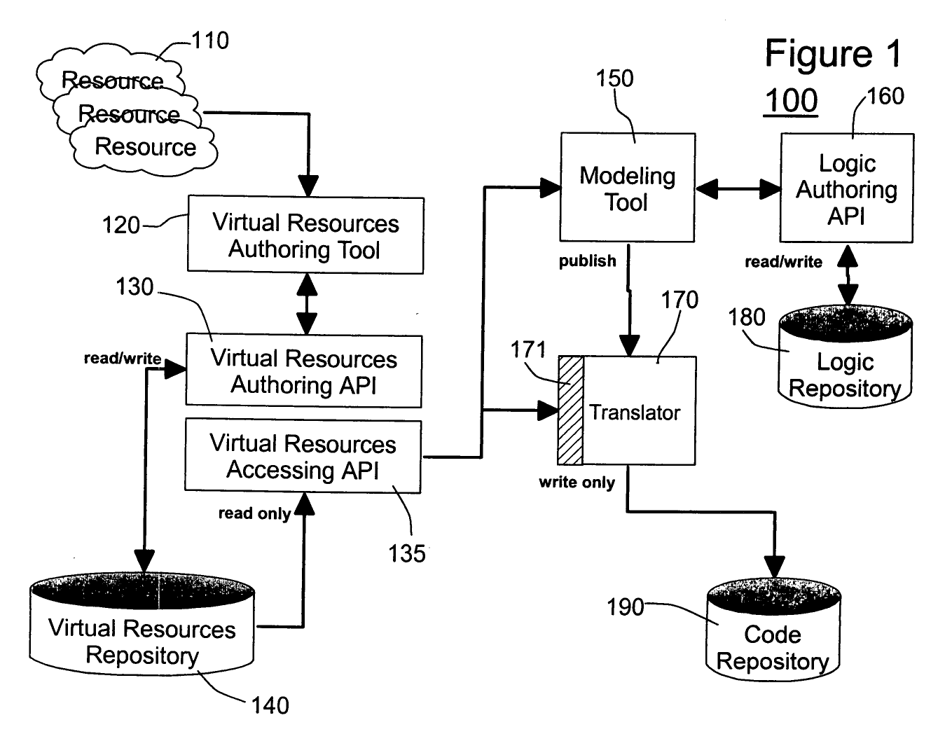

Referring now to the drawings, and more particularly to FIGS. 1-14, there are shown exemplary embodiments of the method and structures according to the present invention.

Generally, the present inventors have recognized that in the course of developing a system directed to authoring of logic by non-programmers, a plethora of problems arise, and when solving these problems, other new problems are introduced.

The invention described herein provides solutions to such problems with respect to resources. It comprises a layer of meta-data and associated operations that promote logic authoring by non-programmers utilizing imagined and/or already realized resources.

This virtual layer facilitates hiding complexities of resources, presenting a consistent facade across non-homogeneous resources, organizing resources into domains, placing constraints on resources, providing multiple customized views of resources, and virtual single-step navigations across potentially elaborate relationships amongst resources.

Further, this is accomplished without placing any additional requirements upon the resources themselves.

Thus, in the example of the automobile above, whereas the conventional techniques would actually change the object (e.g., the automobile) itself in providing different views, the invention does not change the object and indeed provides a “read-only” version of an object (e.g., product) which does not allow an actual changing of the object, but merely a view of the object, and uses some of the same information in providing a view to different types of users (e.g., different members of the audience).

Hence, the invention provides an interface (e.g., layer) which uses some of the same information on an identical object depending upon the audience, and makes it easy for different types of people to use the resources or information without needing to know everything (e.g., background, etc.) to use such information.

### Exemplary Embodiment

Turning now to FIG. 1, a first exemplary embodiment of a system 100 is shown according to the present invention.

System 100 includes resources 110 (e.g., actual resources such as an “automobile” and which truly exist in the real world and which a user will attempt to describe), which may be provided as inputs to a virtual resources authoring tool 120.

A virtual resources authoring application programming interface (API) 130 is selectively connected to the tool 110 and to a virtual resources repository 140 for reading therefrom and writing thereto. A virtual resources accessing API 135 is provided with a read-only capability in relation to the virtual resources repository 140. The repository 140 may be in XML or could be provided in other languages or representations.

Hence, the resources 110 are authored by the virtual resources authoring tool 120 to create, via the virtual resources authoring API 130, something which resides in the repository 140. Thus, the virtual resources are defined.

To use the virtual resources defined (e.g., created) and currently residing in the repository 140, the virtual resources accessing API 135 reads the virtual resources from the repository 140, and provides them to a particular accessor. Some exemplary virtual resources (e.g., virtual name, actual name, collection description, etc.) are described below. Hence, in one case, the particular accessor may be a modeling tool 150, whereas another particular accessor may be a translator 170. Indeed, a query may be made to the repository 140 as to what virtual resources exist therein.

Thus, the modeling (e.g., logic authoring) tool 150 receives an output from the virtual resources accessing API 135.

The tool 150 (e.g., assuming that the tool is a logic authoring tool and thus has a logic authoring process) publishes an output to a translator 170. The publish phase causes the invocation of the translator 170, and the translator 170 also uses the virtual resources accessing API 135 to translate virtual resources to actual resources, so that they may actually be used at runtime. Specifically, the translator 170 writes such code into the code repository 190. The tool 150 also can provide an output to a logic authoring API 160.

The Modeling Tool 150 utilizes the logic authoring API 160 to read/write from/to the logic repository 180. Repository 190 stores therein serialized objects (e.g., logic) which may refer to virtual resources.

Translator 170 has a write-only capability to a code repository 190, which stores, for example, Java class files, which may be available at run-time. It is noted that there must be some mechanism for translating the virtual resources to actual resources for them to be useful.

It is noted that the logic translator 170 (or at least a portion 171 of it), the Modeling Tool 150, the logic authoring API 160, logic repository 180, and code repository 190 are not part of virtual resources themselves. Indeed, virtual resources at runtime do not exist. Thus, these components are authoring time artifacts. Moreover, the right-hand side of FIG. 1 shows an example of how the invention can be used in a useful way.

Thus, FIG. 1 shows the virtual resources (VRs) system components are the virtual resources authoring tool 120, the virtual resources authoring API 130, the virtual resources accessing API 135, and the virtual resources repository 140 and how they operate and interact with the rest of the system which was constructed to allow authoring of logic by a non-programmer or the like. Additionally, as shown in FIG. 1, at least a portion 171 of the translator may be a part of virtual resources.

Thus, in operation, the authoring of logic for electronic execution often involves access to the “resources” 110 (e.g., the actual resources), a loose term which in this context means data (e.g., databases, Java® object attributes, etc.) or functions (e.g., SQL queries, Java® object method calls, etc.). When authoring of logic occurs, normally some form of access to resources is required to at least assure existence and some degree of type safety. Such access may be actual (e.g., to a Java® class containing a method) or imagined (e.g., to a Java® interface or abstract class). Naturally, when executing the authored logic, access to the referenced resources is mandatory.

Herein, a resource used at runtime is referred to as an “actual resource” (AR), whereas a resource utilized at logic authoring time is referred to as a “virtual resource” (VR).

In an exemplary embodiment, the invention provides an Application Programming Interface (API) and an eXtensible Mark-up Language (XML) schema that provides for regularized management and definition of virtual resources. The XML meta-data describes actual resources (e.g., imagined or realized). The API is used to interrogate and manipulate the XML meta-data. Such a combination provides the advantages described above and an inventive aspect of the present invention.

It is noted that XML is merely exemplary and that other languages or representations could be employed, as would be known by one of ordinary skill in the art taking the present application as a whole. Indeed, such could be represented in a database, could be represented as files, etc. The actual persistence mechanism is not limiting to the present invention.

The VR framework is intended to provide a buffer between the virtual (e.g., modeling time, such as a logic authoring time) and real (e.g., runtime) worlds. Some parts of the VR framework are oriented towards the virtual world only, such as user-friendly name, extended constraints, etc. Other aspects of the VR framework are targeted at establishing a deterministic mapping between the VR and corresponding AR.

Virtual Resources may contain any or all of the following information, including one virtual name, one actual name, one collection descriptor, one image (icon), one or more domains, zero or more attributes, zero or more methods, zero or more validators, one resource implementor, one description, and one last modified date and time.

Virtual Attributes may contain any or all of the following information including one virtual name, one virtual type, one image (icon), one actual name, one actual type, one associated virtual resource, zero or more virtual validators, one description, and one access descriptor.

Virtual Methods may contain any or all of the following information including one virtual name, one virtual type, one image (icon), one actual name, one actual type, one associated virtual resource, zero or more virtual parameter descriptors, zero or more virtual exception descriptors, zero or more virtual validators, one description, one constructor descriptor, and one instance descriptor.

There are similar descriptors for parameters, exceptions, and validators.

Virtual Relationships may contain any or all of the following information including one target virtual resource name, one root virtual resource name, one virtual relationship name, one image (icon), one or more virtual relationship types (e.g., this type can carry agreed upon semantics that can be leveraged by the user of the resources), one relationship implementor, one description, and one target instance naming scheme.

Management of the virtual resources is effected through associated methods. The invention establishes methods to create, retrieve, update, and delete virtual resources. Other methods get, set, test, and transform.

Further, there are descriptors defined for instances of resources, relationships, and so forth.

VR information combines information and methods useful for diverse purposes such as rule authoring and code generation. Importantly, VRs can potentially be utilized beyond these initial targets in other technologies where resources are encountered.

It is noted that while FIG. 1 exemplarily shows the virtual resources being used by a logic authoring tool, the virtual resources could be used by other tools which are not logic authoring tools (e.g., such as business modeling tools, system management tools, business analysis tools, application integration tools, network management tools, 3D visualization tools, data and structural modeling tools, diagnostic and repair tools, etc.).

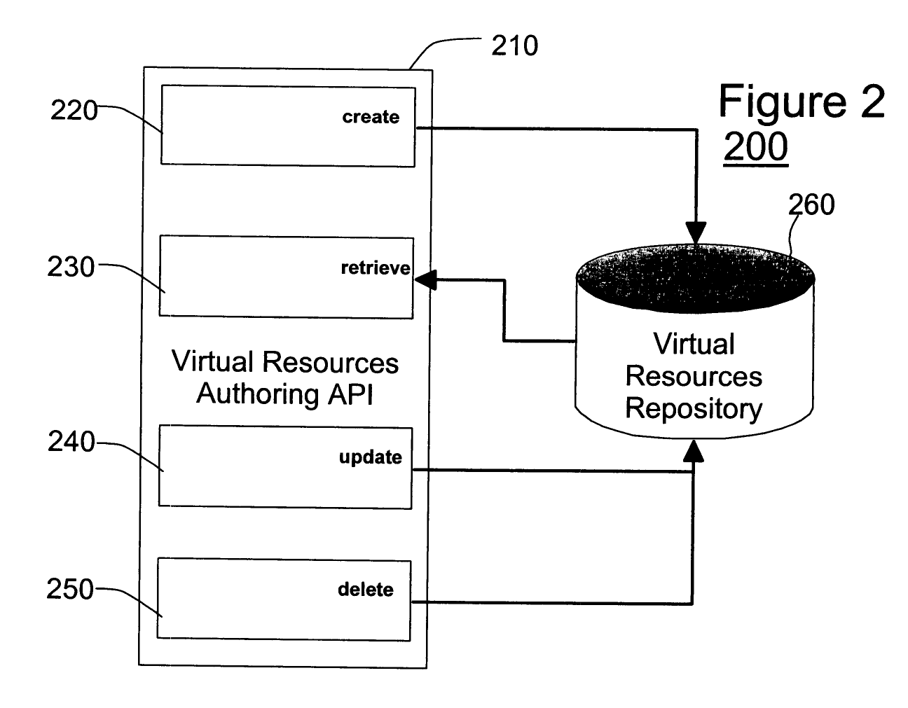

Turning to FIG. 2, a virtual resources life cycle operation 200 is shown for use in authoring according to the present invention.

Specifically, the virtual resources authoring API 210 (e.g., the same as API 130 shown in FIG. 1) may include a plurality of life cycle operations including “create” 220, “retrieve” 230, “update” 240, and “delete” 250. These operations are contained in the API 210 to allow manipulation of the virtual resources in the virtual resources repository 140 (e.g., shown in FIG. 1). In operation, the authoring tool may invoke the “create” operation to create a new entry in the virtual resources repository 210.

Thus, if one is there and using the analogy of the car above, if the user has an actual car, and wishes to describe it in some way, then the user would want to “create” (using create 220) a virtual car and as part of that creation process, something will be placed in the virtual resources repository 260.

Similarly, “update” 240 could be employed to update a virtual resource. That is, given the above-described example of a car, if one was interested in “tell me what the make of the car is”, this could be an update to an existing virtual resource.

Additionally, “update” 240 can also encompass the method or way of the question/query being exposed to the user. Thus, if the question syntax was incorrect or not desirable (e.g., the phrase “tell me the color”), then the statement could be revised to the phrase “show me the color” by using the “update” 240. This “update” would be a different way of seeing the same thing.

Additionally, “delete” 250 could be used when a virtual resource is not needed any longer. For example, assume that one can inquire about a car's color and it is determined that such is not a good question to ask any longer. Thus, if such is not desired any longer, then it can deleted by code representing “do not show color any longer” and do not allow such a question (e.g., “what color is the car?”) to be asked any longer.

Thus, in the invention, logic authoring can proceed even if resources are not completely described, and even if an implementation does not yet exist. However, the implementation is preferably known at code generation/translation time (e.g., see FIG. 1). Conversely, direct referral to resources dictates that the actual resources must exist prior to logic authoring.

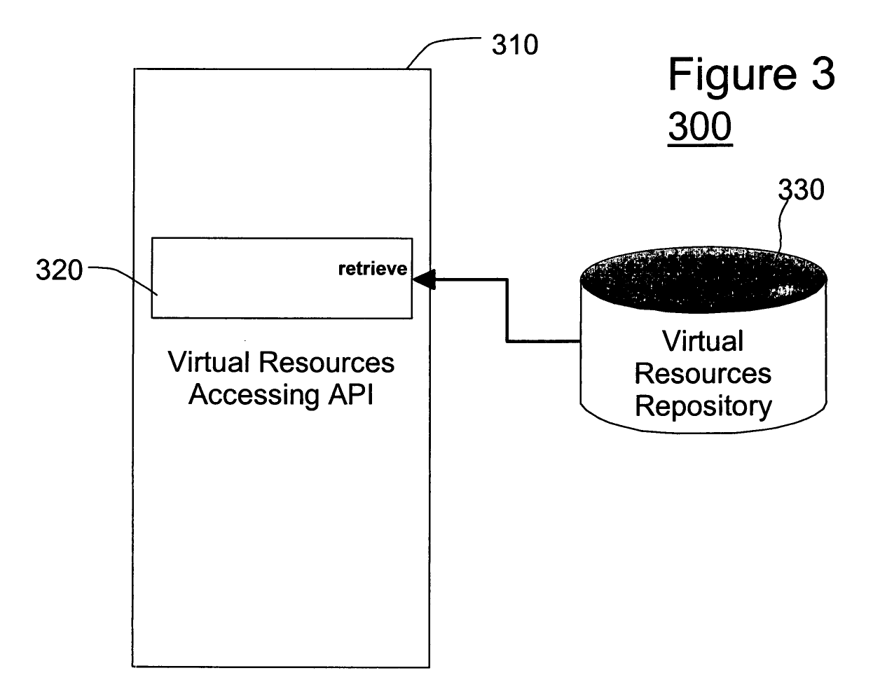

Thus, FIG. 2 shows the full power of using the invention by an unencumbered user (e.g., virtual resource authoring privileges). In contrast, FIG. 3 shows a limited subset of operations available to a restricted user who is allowed only to look (e.g., read-only) at the virtual resources, as opposed to looking at and manipulating (writing) the same.

That is, FIG. 3 illustrates a virtual resources life cycle operation 300 for use in accessing according to the present invention, and specifically a restricted user is allowed only to look at the virtual resources in a virtual resources repository 330 via a retrieve 320 of a virtual resources accessing API 310. In FIG. 3, the user cannot write (author). Hence, depending upon the privileges given to a particular user, the user can author (read/write) or simply read (access).

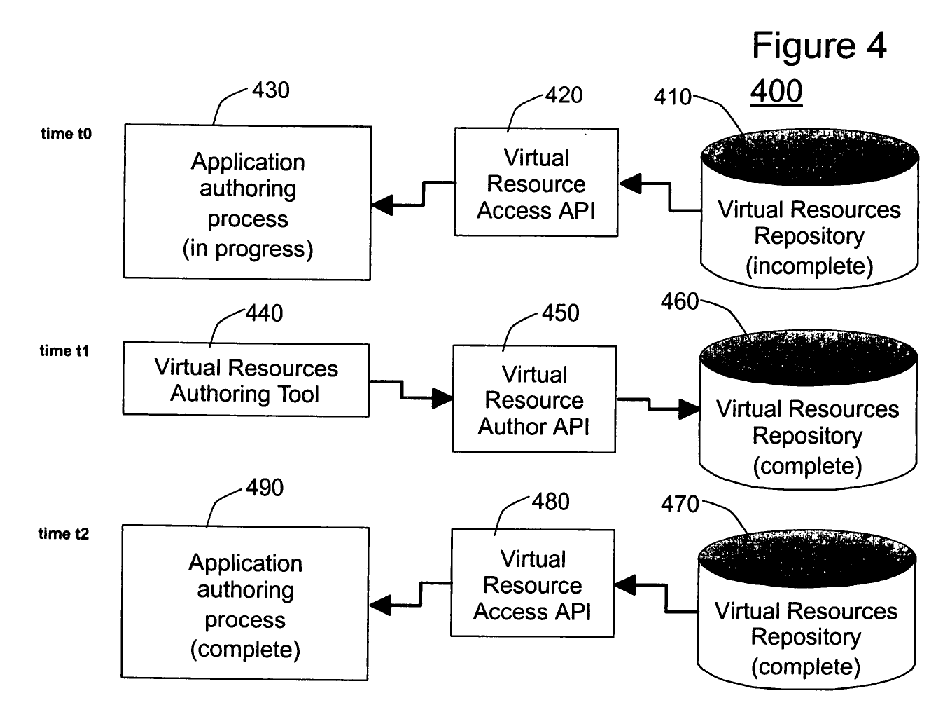

Turning to FIG. 4, FIG. 4 illustrates a structure 400 of virtual resources showing an incomplete state according to the present invention.

Specifically, the user can actually use virtual resources to some degree, even if the virtual resources are not complete. For purposes of the present invention, “complete” means that there is an actual association between a virtual resource and an actual resource.

Thus, for example, one could define a “virtual car” which has various attributes on it by accessing a virtual resources repository 410 through a virtual resource access API, and one could then, at time t0, author logic (e.g., through application authoring process 430) based on the “virtual car”. However, at some point the virtual car must be associated with the actual car. Until such is done, the virtual resources are incomplete. If the virtual resources are complete, then the virtual resources can be transformed into usable entities at runtime. Hence, if one attempted to run at time t0 when the repository 410 is incomplete and the authoring process 430 is in progress, some of the virtual resources have not been mapped or translated into actual resources, and thus there would be no runtime since the translation process would fail.

In contrast, at time t1, a virtual resources authoring tool 440 has been used, via the virtual resource author API 450, to complete the virtual resources repository 460.

At time t2, a translation can be performed which will work. That is, the virtual resource access API 480 can access the virtual resource repository 470 (the virtual resources of which are now complete) to allow application authoring process 490 to be completed.

It is noted that the above operation is not mandatory or required to occur. Indeed, virtual resources may already be completely defined in advance, and there would be no need of the above operation. However, the above operation shows the flexibility of the present invention, and shows one can look ahead and proceed to author or use the virtual resources repository even if the virtual resources are not completed. Thus, parallel operations can be conducted, and authoring can begin even if the repository is not completed. Hence, in software terms, the actual objects themselves may not even exist yet (e.g., the programmer may be building them and they may not be named, worked on, mapped onto the virtual resources, etc., before the objects are completed). By the same token, the virtual resources can be worked on to author rules. As such, the invention can provide a “late binding” between actual resources and virtual resources.

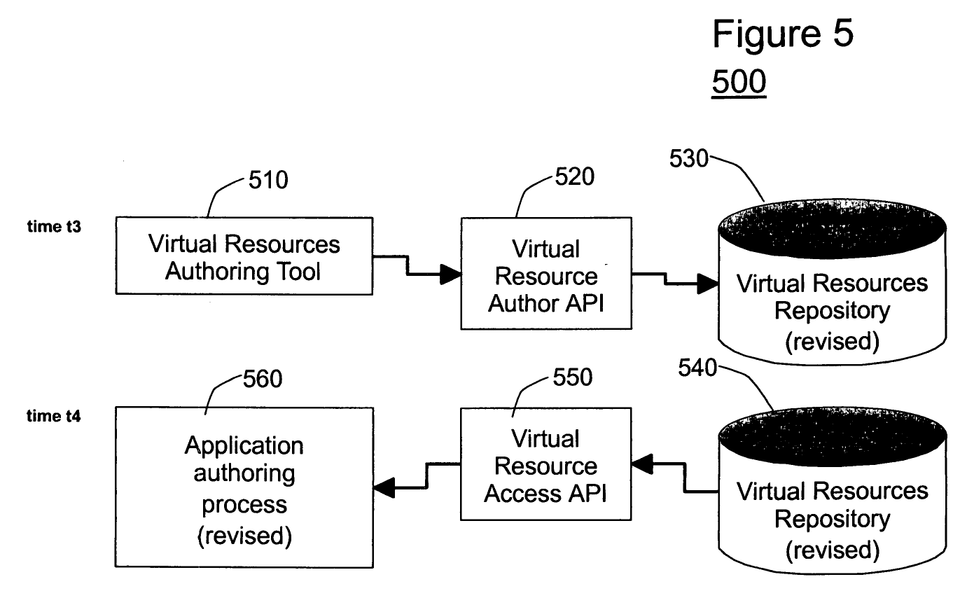

FIG. 5 illustrates a structure 500 showing a revising state according to the present invention. Specifically, FIG. 5 shows a binding operation has previously occurred, but now a different binding is desired by the user.

Alternatively, one might show a particular method being available (e.g., “show me the color”) and then one may want to revise the postulate to “get me the color”. Thus, “show me the color” may no longer be available for the application accessing process, but “get me the color” is available. Hence, one may make changes to the virtual resources later, and either the authoring part gets changed, or what is produced gets changed.

Thus, at time t3, the virtual resources authoring tool 510, via the virtual resource author API 520, is revising the virtual resources repository 530. In FIG. 5, it need not be a change, but could be an add (or a delete). For example, at time t3, one might decide to add “number of wheels on the vehicle”. Before such a revision was made, the application authoring process would not have been able to ask such a question (e.g., “how many wheels are on the vehicle?”).

However, at time t4, the application authoring process 560 could ask such a question. Thus, an update was made to expose the question. Hence, the revised virtual resources repository 540 is being used, via the virtual resource access API 550, by the application authoring process 560. Thus, the application answer to how many wheels are on the vehicle could be provided.

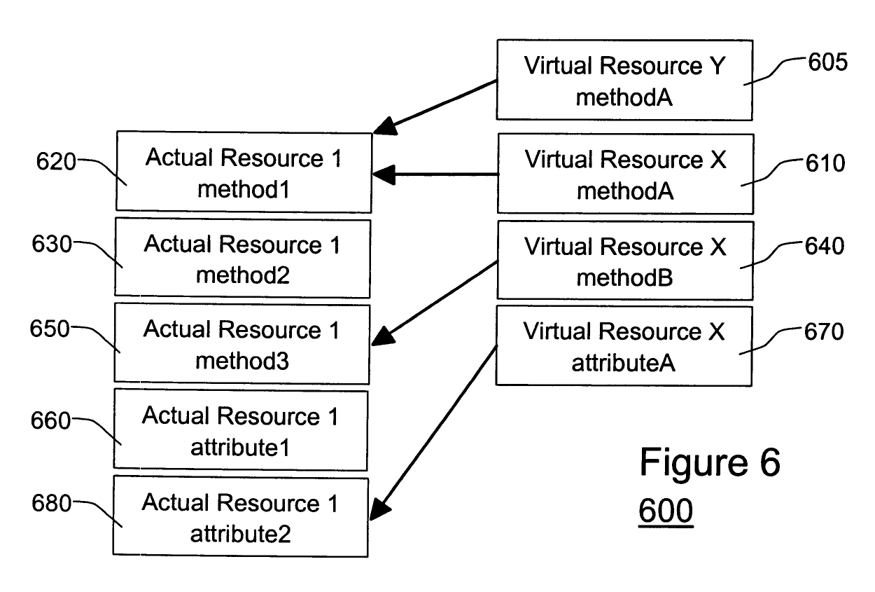

FIG. 6 illustrates a structure 600 showing a cloaking (e.g., hiding from the user) and re-naming state according to the present invention. Such features in the context of FIG. 1 would be provided, for example, when creating the virtual resources, in the operation between the vital resources authoring API 130 and the virtual resources repository 140, and, when looking at them (e.g., accessing them), in the operation between the virtual resources accessing API 135 and the virtual resources repository 140.

As shown in FIG. 6, actual resource 1 method2 630 (as well as Actual Resource 1 attribute1 660) is being cloaked (e.g., hidden) from the user. Thus, the virtual resources are not exposing actual resource 1 method2 630 or Actual Resource 1 attribute1 660.

Regarding “renaming”, virtual resource X methodA 610 is a rename of Actual Resource 1 method1 620, virtual resource X methodB 640 is a rename of Actual Resource 1 method3 650, and virtual resource X attributeA 670 is a rename of Actual Resource 1 attributed 680. Again, the virtual resources are the things which are exposed via the API.

It is noted that, while not shown in FIG. 6, the invention may provide two names for the same virtual resource. Thus, for example, both Virtual Resource Y methodA 605 and Virtual Resource X methodA 610 could both refer to Actual Resource 1 method1 620. Hence, given an actual resource (e.g., Actual Resource 1 method1 620), many names can be provided for the same and the invention provides the capability to call it anything desired as many times as desired (e.g., “X”, “Y”, “Z”, etc. any number of times). Indeed, there need not be a one-to-one correspondence between virtual resources and actual resources, but there may be a many-to-one correspondence. With such a capability, the view can be customized to the relevant (targeted) audience.

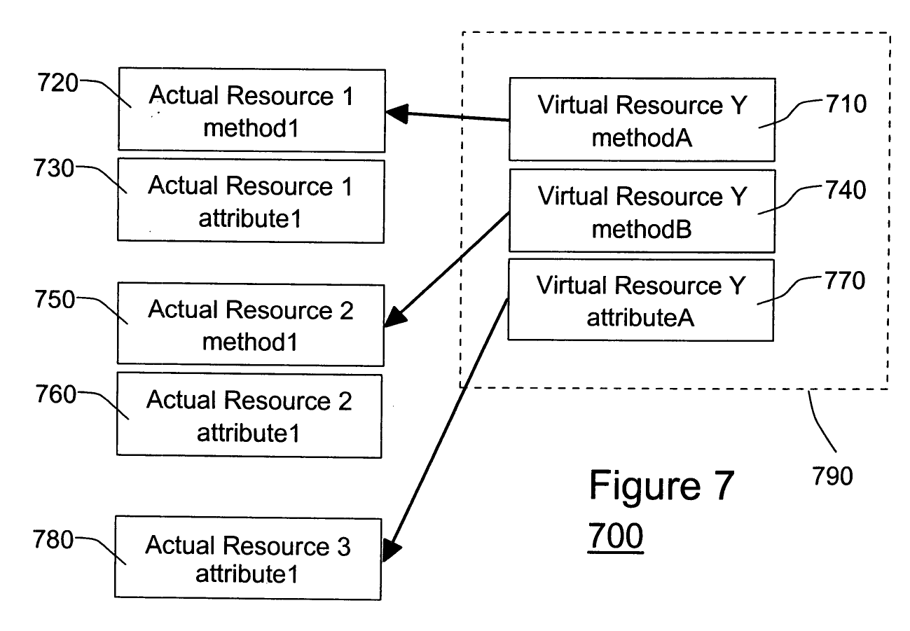

FIG. 7 illustrates a structure 700 showing a composing and re-naming state according to the present invention. FIG. 7 is different from FIG. 6 in that the same virtual resource (e.g., Virtual Resource Y) is mapping to different actual resources (e.g., Actual Resource 1, Actual Resource 2, and Actual Resource 3).

All of the virtual resources are called Virtual Resource Y, except that MethodA is obtained from Actual Resource 1, MethodB is obtained from Actual Resource 2, and attributeA is obtained from Actual Resource 3. Thus, one can compose a large virtual resource which adds methods from various actual resources. Hence, in FIG. 7, a virtual composition is made of three actual resources into one virtual resource 790. In the virtual world (domain), it is known as “Virtual Resource Y”, but in the actual world (domain) there are three actual resources (e.g., Resources 1, 2, and 3).

As shown in FIG. 7, Virtual Resource Y methodA 710 is the rename of Actual Resource 1 method1 720. Virtual Resource Y methodB 740 is the rename of Actual Resource 2 method1 750. Virtual Resource Y attributeA 770 is the rename of Actual Resource 3 attribute1 780. Also shown are Actual Resource 1 attribute1 730 and Actual Resource 2 attribute1 760 which are shown as being cloaked from the user.

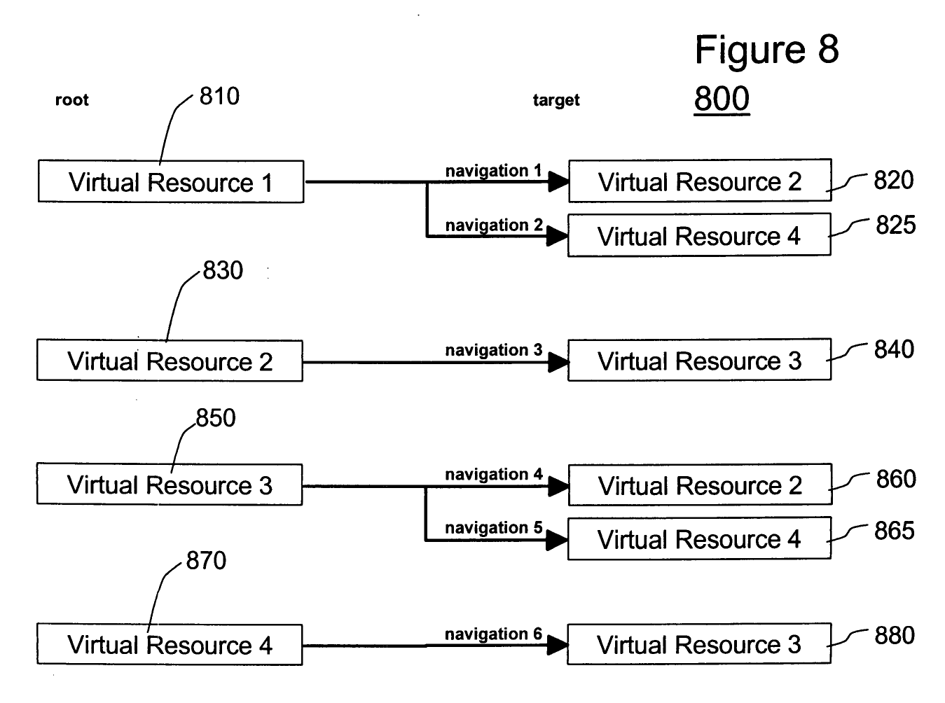

FIG. 8 illustrates a structure 800 showing relationships according to the present invention.

Specifically, there are relationships between virtual resources 810-880 as shown. Thus, the invention captures virtual resources which are related to one another, and that part of the relationship provides information that is also judging how to navigate from one instance of the resource to another.

For example, assume that virtual resource 1 810 is a “shopping cart” and that there is a relationship between a shopping card and a customer ID. Customer IDs are a key onto a customer. Thus, there is a relationship between “shopping cart” and something called “customer”, which are two virtual resources. Hence, when one has a “shopping cart”, one can obtain information about “customer”.

Thus, if one has a virtual resource 1 (e.g., “shopping cart”) 810, then it is possible to get (e.g., navigate) to a second virtual resource 820 called “customer”. Hence, if a navigation is invoked called “get customer” on virtual resource 1, then one would also get to virtual resource 2 (820) (e.g., “customer”).

Thus, as far as the API is concerned, given a root virtual resource, the user can ask to what target virtual resources can the user get. Hence, the user can ask Resource 1 what target virtual resources can the user get to, and the Resource 1 (e.g., “shopping cart”) 810 would return that the user can get to “customer” (virtual resource 2 820) as well as get to Virtual Resource 4 (825), which might be “retailers”.

Similarly, with regard to Virtual Resource 2 (830) the user could navigate to virtual resource 3 which might be “shopping preferences”. Additionally, using virtual resource 3 (850), navigation can occur to either virtual resource 2 (860) or virtual resource 4 (865). Finally, as shown in FIG. 8, using virtual resource 4 (870) as a root, it is possible to obtain virtual resource 3 (880) through navigation.

Thus, FIG. 8 shows how the navigation may be carried out, but such is not shown as part of the virtual resource. That is, it is not shown or known to a user or an accessor of the virtual resource. It is known by the author of the virtual resource relationship, since someone must say this is how the navigation must be performed.

Hence, there are several views of the relationships including one view of defining the relationship (e.g., by authoring) such that it is determined how to get from point A to point B. However, when a user has only read-only privileges as described above (e.g., a user of the resources) and the user is merely looking at how to get from one point to another, there is no consideration or caring of how to navigate or how it actually occurs. It is enough for the user to know that the user can get from the “shopping cart” to the “customer”, and from the “customer” to his “preferences”. Thus, FIG. 8 shows a simplification mechanism.

Navigations can be single-step, or multi-step (not shown). For example, a multi-step relationship could be “getCustomerMailingAddress” that navigates from “shopping cart” to “customer”, then from “customer” to “address”. Additionally, other relationship types, other than the one-way get from point A to point B described herein, are possible. Further, it is noted that the relationships could carry semantics other than “reachability” which is the one assumed above.

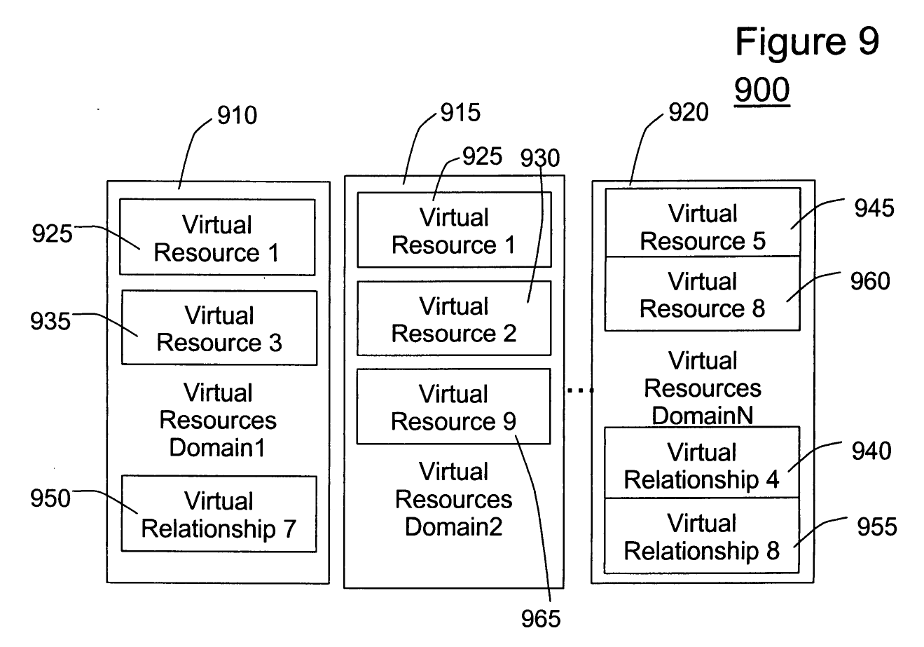

FIG. 9 illustrates a structure 900 showing domains according to the present invention.

More specifically, FIG. 9 illustrates that virtual resources (e.g., 925, 930, 935, 945, 960, 965, etc.) and/or virtual relationships (e.g., 940, 950, 955, etc.) may be organized into respective domains (e.g., domains 910, 915, 920) (e.g., categories), and may appear in more than one domain (e.g., virtual resource 1 925). The organization of the virtual resources need not necessarily comply with how the actual resources themselves are organized (assuming that they are even organized at all).

Hence, for example returning to the example of a car, domain 1 may be what the mechanic would want to know (e.g., what the mechanic sees), domain 2 may be what the customer would like to know, and domain 3 may be what the car dealer would want to know, etc. These domains are each different views of a collection of virtual resources. The views may be similar, dissimilar, or identical. By the same token, preferably the views are not identical or reflect reality (e.g., match directly onto what actual resources are), as the utility would not be as high. Again, the present invention allows the groupings of virtual resources to be tailored to the audience, and situated to provide the most usable or the view with the optimal utility to the audience.

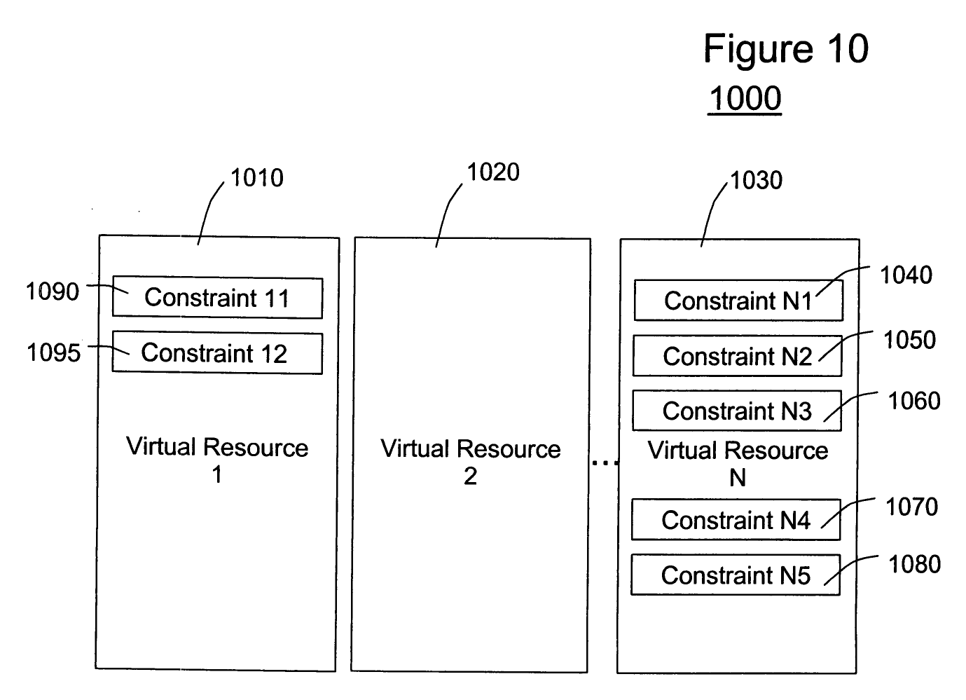

FIG. 10 illustrates a structure 1000 showing constraints according to the present invention. More specifically, it could be the case that on a particular resource, the values that are allowed are unconstrained. For example, a car may have a method on it entitled “the color”, and that there are no constraints on it. The car's color could be set to any color (e.g., mint green, aquamarine, chartreuse, etc.) the user desires.

However, with the method of the invention as shown in FIG. 10, it can expose a virtual resource (e.g., 1010, 1020, 1030) to the user which would allow the user to set the color to only red, white, or blue. Thus, the structure of FIG. 10, with the virtual resources constraints (e.g., 1040-1090), provides the capability of constraining the invoker of setting the color to only red, white or blue, even if the actual method itself would accept any color. The object/actual resource (“the car”) itself is not changed to accept only certain colors, but instead the invention allows defining a virtual resource which only accepts a certain set of colors. Such constraints can be placed selectively on any desired virtual resource, even though the actual method itself allows anything.

Again, looking at FIG. 10 and keeping the above example of the car in mind, Virtual Resource 1 1010 may be “the car”, whereas constraint 11 1090 may be “colors on car can only be red, white, and blue”. Constraint 12 1095 may be “number of wheels on car is four”. Such a view could be a manufacturer's view.

It is noted that virtual resource 2 1020 has no constraints, and thus the car could be set to have any color and any number of wheels. That is, whatever is being exposed has no limits. Such a view could be the automobile designer's view since the designer can set freely the number of wheels and color to any desirable value. Hence, in contrast to virtual resource 2 1020, virtual resource 1 1010 (which may describe the same actual resource as that of virtual resource 2) has limits placed thereon in what is being exposed to the user.

Further, it is noted that, as shown by virtual resource N 1030, there are no limits to the number of virtual resources, or on the number of constraints being placed on the virtual resources. Additionally, while the virtual resources exemplary discussed above happened to match the same actual resource, such is not required by the present invention. As made evident by the exemplary case, virtual resources can be presented in different ways with respect to constraints. Hence, the virtual resources may (or may) not map to the same actual resource. While the exemplary case discussed above with respect to FIG. 10, each virtual resource has described the same actual resource, in that the virtual resource can be constrained in different ways to create a different view of the same actual resource.

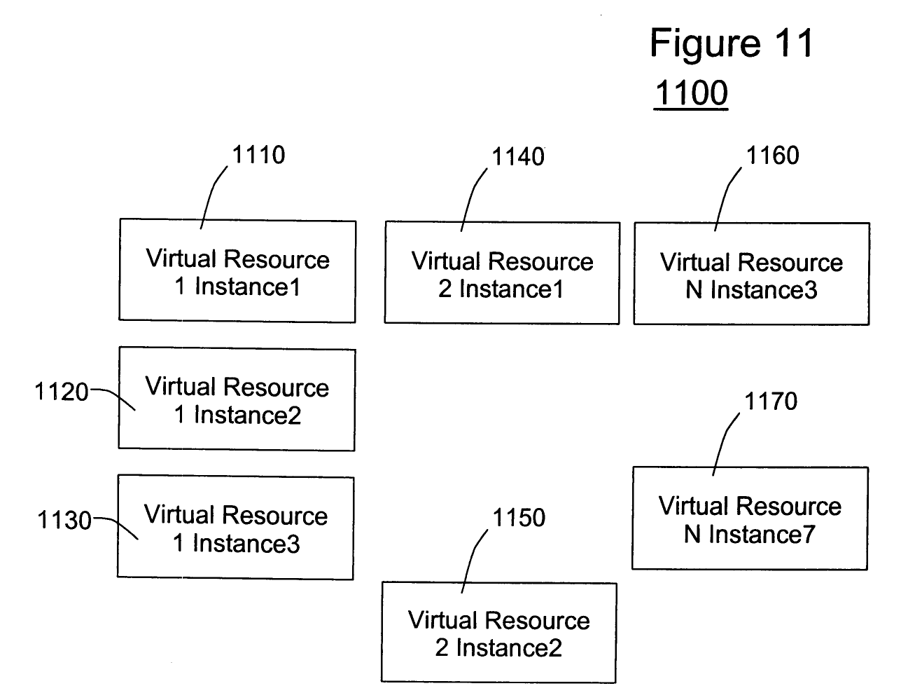

FIG. 11 illustrates a structure 1100 showing different instances of the same virtual resource according to the present invention.

More specifically, for example, when authoring a rule, an author may find that a virtual resource may be an integer. For virtual resource 1, there may be three (3) integers of interest, but each may have a different purpose. Thus, a first instance (e.g., 1110) of the integer may be “age”, a second instance (e.g., 1120) of the integer may be “day of month”, and a third instance (e.g., 1130) may be “month of year”. Hence, each instance is an integer, but the instances have been named differently. Virtual resource 2 has two instances (e.g., 1140 and 1150), whereas Virtual resource N has instance 3 1160 and instance 7 1170. Thus, it is noted that there may not always be an “instance 1”. “Instance 1” is just a name.

Thus, this aspect of the invention allows one to uniquely identify a particular instance of something within a particular context or scope (e.g., in the present case, in the scope of the rules of logic authoring or the like). The exemplary API of the invention allows, given a particular integer, to create an instance and provide a name to it. Hence, depending upon the instance of the same resource, a different meaning (name) may attach to it. In a sense, it is in the eyes of the beholder, since the beholder provides the name (and thus the meaning) to the instance. The name itself is meaningful only to the assignor and users of the name. As such, it is a type of conflict resolution mechanism.

Looking again at the exemplary tool, in operation, there may be a palette of virtual resources available to the author, and one of the resources available may be “integer”. Thus, the author may go to the palette, select “integer”, and “drag” “integer” into the work area. The first instance of dragging “integer” will present an opportunity to name the first instance, and such an instance may be named “age” by the author. The next time the author goes to the palette, selects “integer” again, and drags it to the work area, a different name (e.g., “day of month”) will be given to “integer”. Thus, the same virtual resource has been used twice, but two different names have been give to the virtual resource, with the first having been named “age” and the second having been named “day of month”.

This concept of instances provided by the invention allows much flexibility to the user (e.g., author, designer, etc.).

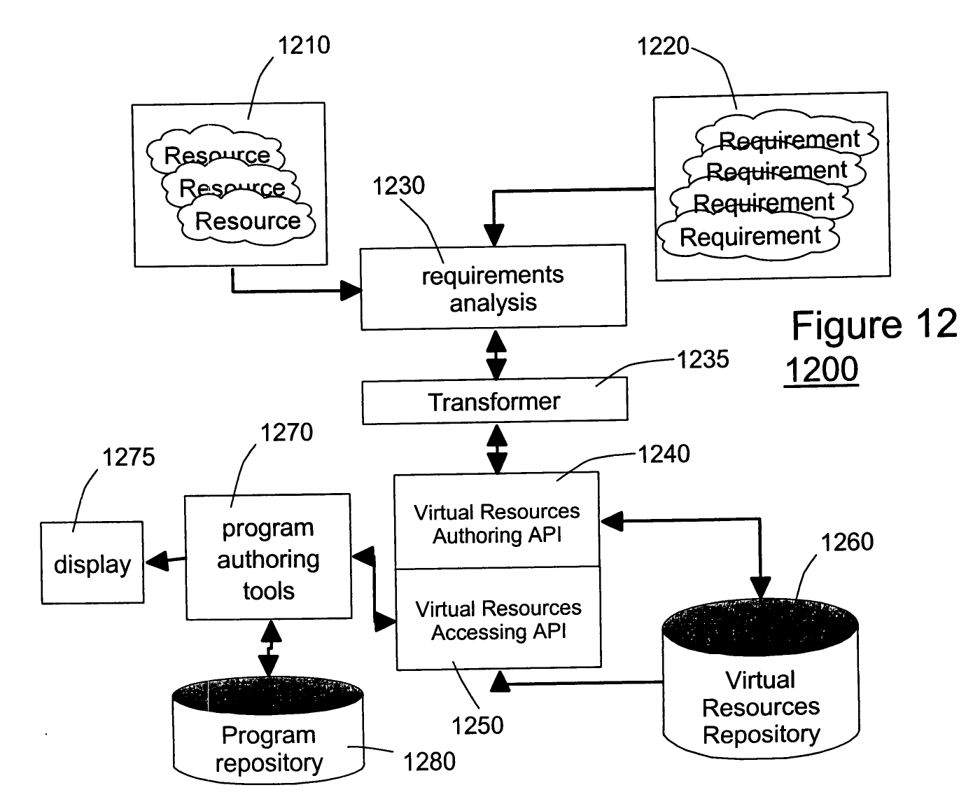

FIG. 12 illustrates a structure 1200 showing service according to the present invention (and how a service provider may use the present invention).

The focus of FIG. 12 is how to provide a service of virtual resources (e.g., how to use and deploy them).

First, one must understand what actual resources 1210 there are and what the requirements 1220 (e.g., who is going to be doing authoring and what should they see; how many views; what different types of programs are available to the designer; privileges and confidential resources available depending upon each domain) are, and based upon understanding those requirements, then creating a constellation of virtual resources which would be used in the environment that was determined in the requirements analysis 1230.

A transformer 1235 is preferably provided between the requirement analysis (analyzer) 1230 and a virtual resources authoring API 1240, and is used to transform the output of the requirements analysis 1230 to produce an output to the virtual resource authoring API 1240 to produce the virtual resources actually required.

The virtual resource authoring API 1240 is used to create the constellation of virtual resources, based on reading from and writing to a virtual resources repository 1260. A virtual resources accessing API 1250 has read-only capability to the virtual resources repository.

The virtual resources accessing API 1250 is also coupled to provide an output (and receive an input) from program authoring tools 1270. Tools 1270 are coupled to a display 1275 and a program repository 1280. Display 1275 may display the entirety of the virtual resources repository that is available or a subset thereof. Additionally, the requirements or requirements analysis may be displayed. There also can be different displays that would show the contents of the resources repository.

As described above (and evident therefrom), the present invention has numerous advantages. One advantage is that equivalent resource implementations can be substituted without any logic authoring changes. For example, assume that there is a virtual resource with virtual name ‘a’ defined as mapped to actual name ‘a0’. The authored logic might be:
if (a>27) then . . .

At code generation time, the substitution of ‘a0’ for ‘a’ would result in:
if (a0>27) then . . .

Later, upon further consideration, a change to virtual resource a might be made so that the virtual resource ‘a’ is mapped to ‘a1’. The authored logic would not be changed, but the VR would have a new implementation resulting in a translation to:
if (a1>27) then . . .

Yet another advantage of the invention is that an implementation can be represented in different ways to suit the intended audience. For example, one audience may know the resource as “Order”, while another audience might know the same resource as “ShoppingCart”. Accomplishment is achieved via multiple domain definitions together with virtual resource naming.

Further, as described above, virtual resources can be composed from multiple actual resources, and actual resources can be decomposed into one or more virtual resources. Besides the examples above, another example of composition might be that there exist two actual resources, HomeownerPolicy and AutoPolicy. One could compose a virtual resource known as PolicyPortfolio that was composed from these two actual resources.

An example of decomposition might be that a LifeInsurancePolicy actual resource might have attributes: name of insured, address of insured, name of beneficiary, amount of coverage, cost of coverage, agent commission, etc. One virtual resource LimitedLifeInsurancePolicy might hide agent commission, while a second virtual resource CompleteLifeInsurancePolicy might expose all attributes.

With direct use of resources, the actual resources themselves are likely defined in terms that the resource creator thought most appropriate. Alternatively, there may be restrictions imposed by the milieux in which the resource definition occurs. For example, the creator of a resource might create a Java® object having a method:
Integer someResource.getValue( );

However, one logic author might be better served by having the resource known as:
Integer person.getAge( );

Yet another logic author might prefer:
“Get the person's age in whole years”
   when referring to the same actual resource, but such designation would not be an acceptable Java® method name, for example.

Another advantage of the present invention, as described above, is the capability to group virtual resources into domains. This allows for partitions (overlapping or not) to be formed for targeted audiences. Thus, the “lending” group would see one collection of resources, while the “brokerage” group would see another collection of resources. For example, in the “lending” domain, there might be “mortgage rates”, “auto rates”, and “customer portfolios” virtual resources, while in the “brokerage” domain there might be “short term rates” and “customer portfolios”. The actual resources referred to by these virtual domains may overlap, but separate and distinct views (virtual resources and relationships) onto the actual resources are advantageously facilitated by the present invention.

When rule authoring, it is advantageous to have a limited display of resources within one or several domains instead of all possible resources. When code generating, it is necessary to determine the actual resource associated with the virtual resource. The invention provides methods to assist in these and other tasks.

Yet another advantage of the present invention is that a common layer is provided to resource utilizing tools, such as logic authoring tools, so that such tools do not need to understand how to access various resources directly, resulting in simplicity of design and implementation of such tools. For example, a rule authoring tool would only need to interrogate the VRs once to get a list of virtual resources in a domain, even though the actual resources themselves might be diverse (database tables, EJBs, JavaBeans, etc.). The present invention provides a degree of homogeneity through virtual resources over a variety of actual resource types.

The present invention also provides methods to locate virtual resources within domains, locate virtual resources by name, create virtual resources, create virtual resource instances, locate target virtual resources from root virtual resource via relationships, get/set virtual resource attributes and methods, etc.

A further advantage of the present invention, as evident from the description above, is that virtual resources need not identically reflect the underlying implementation, permitting hiding and renaming of constituent parts. Actual resources may include attributes and/or methods which are uninteresting, restricted, or forbidden for a domain. For example, an actual resource might have methods ‘x’ and ‘y’. VRs might be constructed so that in domain 1 ‘x’ and ‘y’ are known as ‘p’ and ‘q’ respectively, while in domain 2 ‘x’ is hidden and ‘y’ is known as ‘k’. Further, a virtual resource may expose a virtual method which does not exist as part of any actual resource. For example, virtual method ‘m’ may be comprised of actual method ‘x’+actual method ‘y’.

An additional advantage of the present invention is that relationships can be established between virtual resources. It might be known that given a HomeownerPolicy resource, that navigation to an AutoPolicy via an InsuredPerson resource is possible. This relationship may be unknown to the various resources themselves, but can be captured and utilized using the present invention. Further, VR relationships allow for context sensitive automatic naming of instances by propagating the root instance name onto its related target instance using the logical path (relationship) traversed.

For example, the relationship used might be “placing”, the root virtual resource instance might be “this order”, and the target virtual resource might be “customer”, resulting in the instance of the target virtual resource being named “customer placing this order”. This is referred to as “smart naming” of instances derived through navigation.

Yet another advantage of the present invention is that the inventive system represents complex relationships as flat data, making it more approachable for non-programmers. This is accomplished by allowing the resource administrator the opportunity to pre-navigate for the less skilled target audience.

For example, it may be the case that from virtual resource Order, through a series of navigations, the virtual resource CustomerAddress can be discovered. Instead of making the less skilled rule author try to perform this sometimes complex navigation, it can be described using the inventive virtual resource facilities and made available as something familiar, perhaps “address of customer placing order”.

A further advantage of the present invention is the ability to place constraints upon resources without altering the actual resources themselves. For example, a database column within a table may be defined in such a way as to accept any string of characters. However, using the invention, a virtual resource can be constructed so as to limit the acceptable characters to the two character state abbreviations (e.g., NY), thus constraining the associated actual resource.

Another example, as described above, is a method on a resource may allow any integer value to be accepted, such as:

ActualResource:

void setAge(int newAge) {
age = newAge;
}

However, as described above, it may be desired to constrain the acceptable values for age, such as:

VirtualResource:

void setAge(int newAge) {
if(newAge > 0) {
actualResource.setAge(newAge);
}
else throw new ResourceConstraintException( );
}

Another advantage of the present invention is the capability to name instances of resources. For example, if a virtual resource represents a table, then a virtual resource instance might represent a particular row in said table. The instance (or row) can then be given a user chosen name.

InstanceInfos accommodate an instance name to allow for a unique instance of a virtual resource. For example, there may be a virtual resource called Discount that has attributes for amount and reason. One VR instance of Discount might be named “Independence Day Discount”, while another might be named “Overstock Discount”. This allows the rule author to make distinctions between specific VR instances.

Thus, as described above, VRs provide several key advantages discussed above, including provision of a level of indirection between resource users and resource implementors. This decoupling facilitates independent development of various complex software components, which was previously not feasible.

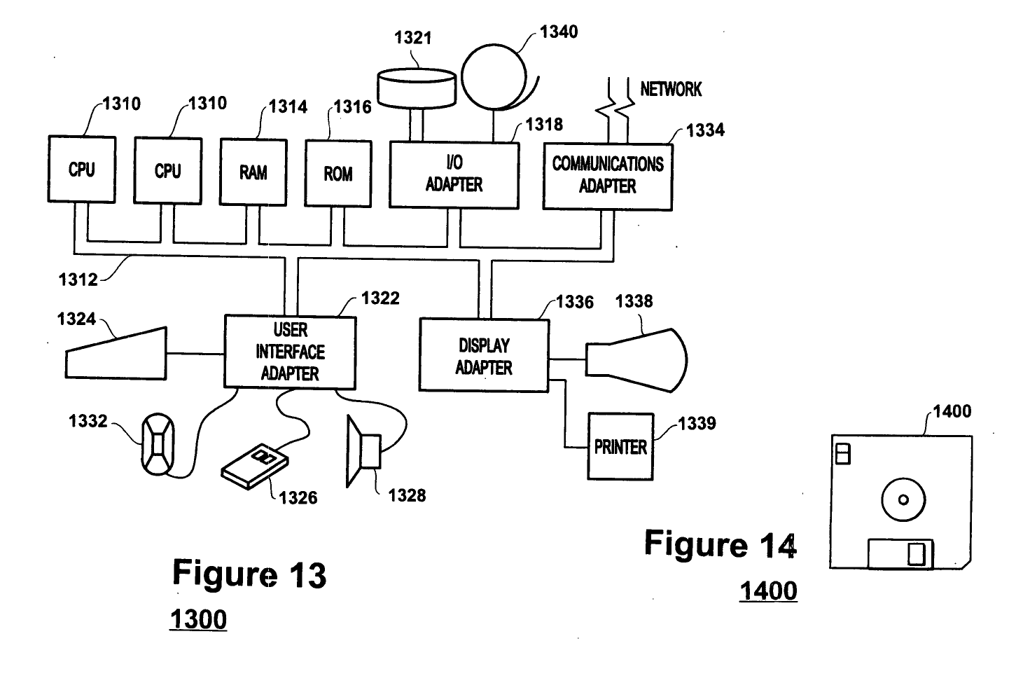

FIG. 13 illustrates a typical hardware configuration of an information handling/computer system for use with the invention and which preferably has at least one processor or central processing unit (CPU) 1311.

The CPUs 1311 are interconnected via a system bus 1312 to a random access memory (RAM) 1314, read-only memory (ROM) 1316, input/output (I/O) adapter 1318 (for connecting peripheral devices such as disk units 1321 and tape drives 1340 to the bus 1312), user interface adapter 1322 (for connecting a keyboard 1324, mouse 1326, speaker 1328, microphone 1332, and/or other user interface device to the bus 1312), a communication adapter 1334 for connecting an information handling system to a data processing network, the Internet, an Intranet, a personal area network (PAN), etc., and a display adapter 1336 for connecting the bus 1312 to a display device 1338 and/or printer.

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

This signal-bearing media may include, for example, a RAM contained within the CPU 1311, as represented by the fast-access storage for example. Alternatively, the instructions may be contained in another signal-bearing media, such as a magnetic data storage diskette 1400 (FIG. 14), directly or indirectly accessible by the CPU 1311.

Whether contained in the diskette 1400, the computer/CPU 1311, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code, compiled from a language such as “C”, etc.

While the invention has been described in terms of several preferred embodiments, those skilled in the art will recognize that the invention can be practiced with modification within the spirit and scope of the appended claims.

Further, it is noted that, Applicant's intent is to encompass equivalents of all claim elements, even if amended later during prosecution.

1. A method of refactoring a plurality of actual resources without alteration into a collection of virtual resources customized to a particular audience, said method comprising:
constructing at least one virtual resource;
connecting at least one actual resource to the at least one virtual resource;
retrieving the at least one virtual resource; and
extracting at least one descriptor from said at least one retrieved virtual resource.

2. The method of claim 1, wherein said connecting comprises directly mapping the at least one actual resource to the at least one virtual resource.

3. The method of claim 1, wherein the constructing comprises at least one of:
renaming a method; hiding a method; composing a method;
renaming an attribute; hiding an attribute; composing an attribute;
assigning to at least one domain; designating as a collection;
assigning to at least one validator; assigning a description;
designating as at least one of ready and not ready; and
assigning a last modified date and time.

4. The method of claim 1, wherein virtual resources are connected to each other through a relationship carrying semantic that can be leveraged by a consumer of resources, comprising:
constructing at least one virtual relationship between at least two virtual resources;
coupling at least one actual relationship implementor to at least one virtual relationship;
performing at least one retrieval of a virtual relationship; and
extracting at least one descriptor from at least one retrieved virtual relationship.

5. The method of claim 4, wherein said coupling comprises:
directly mapping said at least one actual relationship implementor to said at least one virtual relationship.

6. The method of claim 4, wherein the relationship constructing comprises at least one of:
assigning a root virtual resource name;
assigning a target virtual resource name;
assigning a relationship name;
assigning a relationship type;
assigning a description;
assigning a target instance naming scheme;
designating as at least one of ready and not ready; and
assigning a last modified date and time;

7. The method of claim 4, wherein the retrieving comprises locating virtual relationships by at least one of:
a domain;
a name;
a root;
a type; and
a target.

8. The method of claim 1, wherein virtual resources are connected to each other through a model flattening relationship with a semantic meaning of reachability, comprising:
constructing at least one virtual relationship between at least two virtual resources;
coupling at least one actual relationship implementor to at least one virtual relationship;
performing at least one retrieval of a virtual relationship; and
extracting at least one descriptor from at least one retrieved virtual relationship.

9. The method of claim 8, wherein said coupling comprises:
directly mapping said at least one actual relationship implementor to said at least one virtual relationship.

10. The method of claim 8, wherein the relationship constructing comprises at least one of:
assigning a root virtual resource name;
assigning a target virtual resource name;
assigning a relationship name;
assigning a relationship type;
assigning a description;
assigning a target instance naming scheme;
designating as at least one of ready and not ready; and
assigning a last modified date and time;

11. The method of claim 1, wherein the retrieving comprises locating virtual resources by at least one of:
a domain;
a name; and
a relationship.

12. The method of claim 8, wherein the retrieving comprises locating virtual relationships by at least one of:
a domain;
a name;
a root;
a type; and
a target.

13. The method of claim 2, wherein the descriptor validator information is employed to limit actual resource usage.

14. A system for refactoring a plurality of actual resources without alteration into a collection of virtual resources customized to a particular audience, said system comprising:
means for constructing at least one virtual resource;
means for connecting at least one actual resource to at least one virtual resource;
means for retrieving at least one virtual resource; and
means for extracting at least one descriptor from said at least one retrieved virtual resource.

15. The system of claim 14, wherein said means for connecting comprises means for directly mapping the at least one actual resource to the at least one virtual resource.

16. The system of claim 14, wherein the means for constructing performs at least one of:
renaming a method; hiding a method; composing a method;
renaming an attribute; hiding an attribute; composing an attribute;
assigning to at least one domain; designating as a collection;
assigning to at least one validator; assigning a description;
designating as at least one of ready and not ready; and
assigning a last modified date and time.

17. The system of claim 14, wherein virtual resources are connected to each other through a relationship carrying semantic that can be leveraged by a consumer of resources, comprising
means for constructing at least one virtual relationship between at least two virtual resources;
means for coupling at least one actual relationship implementor to at least one virtual relationship;
means for performing at least one retrieval of a virtual relationship; and
means for extracting at least one descriptor from at least one retrieved virtual relationship.

18. The system of claim 17, wherein said means for coupling comprises:
means for directly mapping said at least one actual relationship implementor to said at least one virtual relationship.

19. The system of claim 17, wherein the means for constructing at least one virtual relationship performs at least one of:
assigning a root virtual resource name;
assigning a target virtual resource name;
assigning a relationship name;
assigning a relationship type;
assigning a description;
assigning a target instance naming scheme;
designating as at least one of ready and not ready; and
assigning a last modified date and time;

20. The system of claim 14, wherein the means for retrieving performs locating virtual relationships by at least one of:
a domain;
a name;
a root;
a type; and
a target.

21. The system of claim 14, wherein virtual resources are connected to each other through a model flattening relationship with semantic meaning of reachability, said system further comprising:
means for constructing at least one virtual relationship between at least two virtual resources;
means for coupling at least one actual relationship implementor to at least one virtual relationship;
means for performing as least one retrieval of a virtual relationship; and
means for extracting at least one descriptor from at least one retrieved virtual relationship.

22. The system of claim 21, wherein said means for coupling comprises:
means for directly mapping said at least one actual relationship implementor to said at least one virtual relationship.

23. The system of claim 21, wherein the means for constructing a relationship comprises at least one of:
means for assigning a root virtual resource name;
means for assigning a target virtual resource name;
means for assigning a relationship name;
means for assigning a relationship type;
means for assigning a description;
means for assigning a target instance naming scheme;
means for designating as at least one of ready and not ready; and
means for assigning a last modified date and time;

24. The system of claim 21, wherein the means for retrieving comprises locating virtual resources by at least one of:
a domain;
a name; and
a relationship.

25. The system of claim 21, wherein the means for retrieving comprises locating virtual relationships by at least one of:
a domain;
a name;
a root; and
a target.

26. The system of claim 15, wherein the descriptor validator information is employed to limit actual resource usage.

27. In a system comprised of a plurality of actual resources, a service to manage descriptions of said actual resources comprising:
defining at least one virtual domain to satisfy a requirement analysis; and
defining at least one virtual resource describing as least one actual resource within the at least one virtual domain to satisfy the requirement analysis.

28. The service of claim 27, further comprising:
analyzing a requirement for actual resource usage, to provide said requirement analysis.

29. The service of claim 27, further comprising:
defining at least one virtual relationship between at least two virtual resources.

30. The service of claim 29, wherein at least one of a virtual resource and a virtual relationship are utilized to create an application program.

31. A method of deploying computing infrastructure in which computer-readable code is integrated into a computing system, such that said code and said computing system combine to perform a method of refactoring said actual resources without alteration into a collection of virtual resources customized to a particular audience, said method comprising:
constructing at least one virtual resource;
connecting at least one actual resource to at least one virtual resource;
performing at least one retrieval of a virtual resource; and
extracting at least one descriptor from said at least one retrieved virtual resource.

32. A signal-bearing medium tangibly embodying a program of machine-readable instructions executable by a digital processing apparatus to perform a method of refactoring said actual resources without alteration into a collection of virtual resources customized to a particular audience, said method comprising:
constructing at least one virtual resource;
connecting at least one actual resource to at least one virtual resource;
performing at least one retrieval of a virtual resource; and
extracting at least one descriptor from said at least one retrieved virtual resource.

33. A method of refactoring actual resources without alteration into a collection of virtual resources customized to a particular audience, comprising:
providing a structured meta-data layer which contains semantic information for leveraging by a consumer of the virtual resources.

34. The method of claim 33, wherein said semantic information includes relationships with agreed upon semantics including any of “related-to”, “contains”, and “is-conflicting-with”, between entities.

35. The method of claim 33, wherein said semantic information allows any of making new resource manipulation operations available to logic authoring tools and serving as an input to a conflict detection tool

36. The method of claim 1, further comprising:
creating at least one virtual resource instance;
assigning an identity to the at least one virtual resource instance; and
associating the at least one virtual resource instance with one virtual resource.

37. The method of claim 4, further comprising:
creating at least one virtual relationship instance;
assigning an identity to the at least one virtual relationship instance; and
associating the at least one virtual relationship instance with one virtual relationship.
